(19) United States
(12) Patent Application Publication
(10) Pub. No.: US 2004/0245787 A1
(43) Pub. Date: Dec. 9, 2004

(54) Door lock device

(76) Inventor: Craig D. Quarberg, Monticello, MN (US)

Correspondence Address: NIKOLAI & MERSEREAU, P.A., 900 SECOND AVENUE SOUTH, SUITE 820, MINNEAPOLIS, MN, 55402, US

(21) Appl. No.: 10/736,362

(22) Filed: Dec. 15, 2003

Related U.S. Application Data
(60) Provisional application No. 60/476,797, filed on Jun. 6, 2003.

(51) Int. Cl. E05C 3/14

(52) U.S. Cl. 292/228

(57) ABSTRACT

A lock device for securing a building entry door that can be readily carried in a purse or pocket comprises a three-part assembly of a rigid, generally rectangular strap member of a predetermined length and width dimension and that has a cylindrical stud affixed to and projecting normally from a first major surface of the strap member proximate one end thereof, the strap member also including a pattern of apertures each at a differing distance from the first end of the strap. The second piece comprises a flat rigid plate that is sized to span a gap between a surface of the entry door and a surface of the adjacent door jam with the door closed and formed through the thickness dimension of the plate is a slot through which the strap member can slide. With the stud on the strap member inserted into a recess in the door jam, the door is closed and the plate is slid along the strap until it abuts the door and jam whereupon a pin is inserted through one of the holes in the strap to maintain the plate in engagement with the door and jam.

### BACKGROUND OF THE INVENTION

I. Field of the Invention

This invention relates generally to apparatus for securing a room entry door, and more particularly to a door locking mechanism that is easily carried in pocket, purse or briefcase for use on hotel/motel doors or other room entry doors to provide added security.

II. Discussion of the Prior Art

Travelers may encounter instances where a need exists for a secure lock to prevent unauthorized entry of persons into a room through an entry door. Frequently, restrooms in gasoline stations and the like, are not equipped with a working lock to insure privacy. Also, many hotel/motel room locks are inadequate for their intended purpose of denying entry to unauthorized persons because the lock mechanism built into the door can be readily defeated. Burglars have been known to open a door lock by simply slipping a thin plastic strip, such as a credit card, into the space between a door and its jam to thereby depress the door lock's latch so that it is no longer engaged by the latch plate on the door jam.

It is accordingly a principal object of the present invention to provide a portable door locking mechanism that can be rapidly and easily applied and removed without the use of tools of any kind and that securely locks a door in its closed condition and that can withstand attempts at forced entry.

### SUMMARY OF THE INVENTION

The portable, removable lock mechanism in accordance with a preferred embodiment of the present invention comprises three elements including a metal strap of a predetermined length and width dimension having a cylindrical stud projecting from a major surface thereof proximate a first end of the strap. Formed through the thickness dimension of the strap are a series of circular apertures with a predetermined spacing therebetween.

A second element of the portable, removable lock mechanism is a flat metal plat having a slit formed therethrough, the slit being sized to accept the strap of the first element therethrough.

The third element of the lock mechanism is a cylindrical pin having an outside diameter that is slightly less than the diameter of the apertures formed through the strap of the first element.

In use, with the door slightly ajar, the stud on the first element is placed through the door jam's latch plate and the door is then closed with the strap extending through and beyond the crack between the edge of the door and the adjacent door jam. The plate comprising the second element of the latch mechanism is then slid along the strap until it snuggly abuts the door and jam. Next, the pin is inserted through an appropriate aperture in the strap to hold the plate firmly against the door and jam.

For convenience, a short length of chain or cable may be used to couple the pin to an opposite end of the strap from the stud so that the pin does not become separated from the lock assembly and possibly lost or misplaced.

### DESCRIPTION OF THE DRAWINGS

The foregoing features, objects and advantages of the invention will become apparent to those skilled in the art from the following detailed description of a preferred embodiment, especially when considered in conjunction with the accompanying drawings in which like numerals in the several views refer to corresponding parts.

FIG. 1 is a perspective view of the portable, removable door lock assembly constructed in accordance with the present invention;

FIG. 2 is a partial perspective view of a door and door jam with which the lock arrangement of FIG. 1 may be used to prevent the door from being opened; and

FIG. 3 is a plan view of the door and jam with the lock mechanism of the present invention in place.

### DESCRIPTION OF THE PREFERRED EMBODIMENT

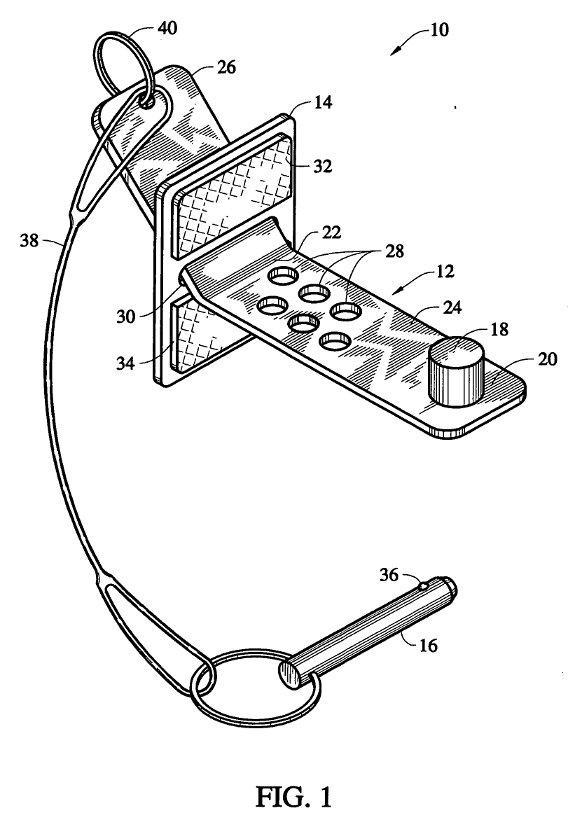

Referring to FIG. 1, the lock mechanism of the present invention is seen comprise three elements, namely, a strap member 12, a plate member 14 and a locking pin 16. The strap 12 is preferably formed from a suitable metal, preferably zinc, and that has a cylindrical stud 18 swaged therein and projecting perpendicularly from a first major surface 20 of the strap. The strap 12 has a bend formed at 22 to effectively divide it into two integrally formed segments 24 and 26. Formed through the thickness dimension of the segment 24 is a plurality of regularly spaced apertures, as at 28.

The plate element 14 is also made of a suitable metal and is generally rectangular in shape, although an oval or circular configuration can also be used. The plate element 14 has a slit 30 formed through its thickness dimension, the slit 30 being of a size permitting the plate 14 to slide along the segments 24 and 26 of the strap element 12. Affixed to the underside of the plate 14 are cork or rubber pads 32 and 34 that are preferably adhesively bonded to the plate 14.

The pin 16 is also made of metal and includes a spring-biased ball detent 36 proximate a free end thereof To avoid loss or misplacement of the pin element 16, it is preferably coupled by a chain or cable 38 to the end of the strap segment 26. The ring 40 connecting to the end of the chain 38 to the segment 26 is of a size that prevents the plate 14 from being stripped off of the strap segment 26. Thus, all of the three elements are connected together with the lock assembly of FIG. 1 is not being used.

Without limitation, the plate 14 may be 1½ in. wide and 2 in. long and with the slot 30 being located midway along the length dimension of the plate. The plate may also be about 0.093 in. thick.

Further, without limitation, the strap 12 may be 0.095 in. thick and be 1 in. wide. The segment 24 may be about 2.673 in. long and the segment 26 about 1.971 in. long. The angle at which the segments 24 and 26 are bent relative to one another may be 135°. The stud 18 affixed to and projecting from the strap segment 24 may be ½ in. in diameter and 0.436 in. high.

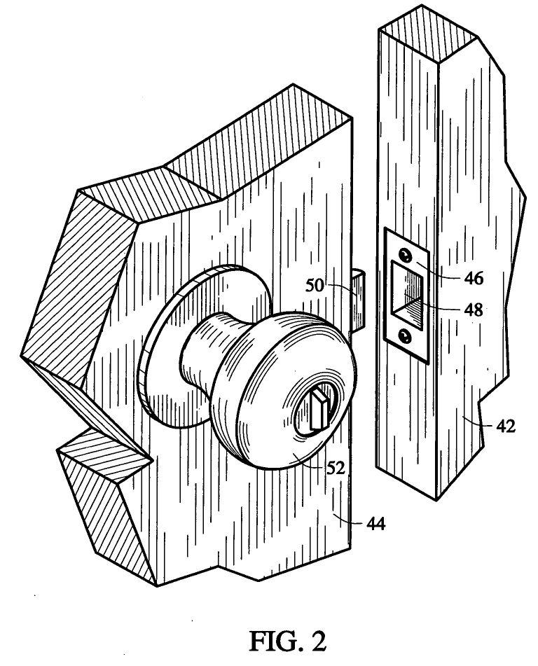

Referring next to FIG. 2, there is shown a partial perspective view of a door jam 42 and an entry door 44 that is slightly ajar to reveal a latch plate 46 that is mounted by screws about a recess 48 in the jam that receives the latch 50 of a conventional door lock set. Rotation of the doorknob 52 causes the latch 50 to move in and out relative to the latch plate 46.

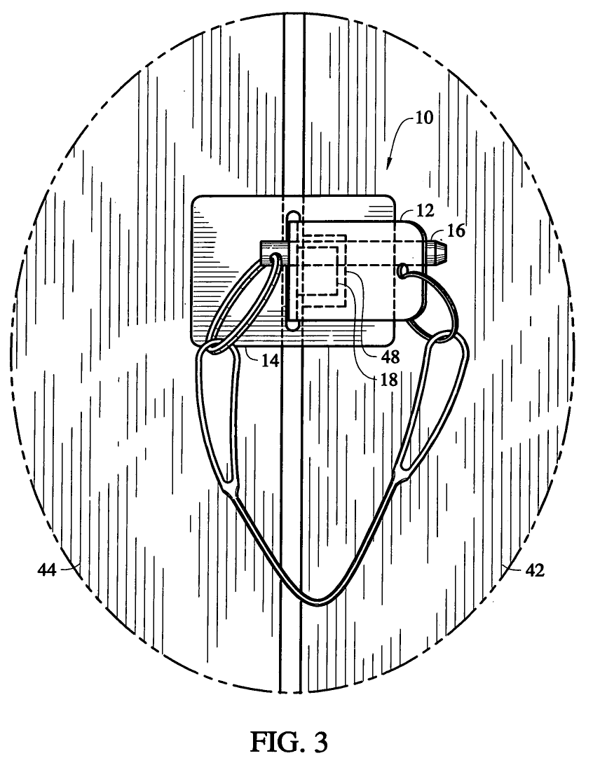

Referring next to FIG. 3, there is illustrated a plan view of the door jam 42 and the door 44 with the door closed and the portable, removable lock mechanism of the present invention installed. To install the lock assembly, before the door is closed, the strap 12 is positioned such that the stud 18 is inserted through the latch plate 46 into the recess 48 in the jam. The door is then fully closed and the plate element 14 is slid along the strap 12 until the cushioned pads 32 and 34 abut the surface of the jam 42 and the door 44. Next, the pin 16 is inserted through one of the apertures 28 that is closest to the plate 14 when the plate 24 is snugged up against the door jam 42 and the door 44. The pads 32 and 34 prevent the door and jam from being scratched or marred. The door is now secured and cannot be opened without first removing the pin 16 from the aperture in which it is disposed and then sliding the plate 14 rearward so that it no longer blocks the door from opening far enough to remove the stud 18 from the recess 48 through the latch plate 46.

By providing a series of apertures 28, the lock assembly of the present invention can be used with doors of differing thickness. Also, because the strap 12 is bent at 22, the segment 26 thereof does not interfere with the doorknob 52.

Because the lock assembly of the present invention is relatively small in size, light in weight and all of its operational parts are held together as a unit, it can be conveniently carried in one's pocket or in a purse or briefcase to be used on an as-needed basis. Also, if desired, one can mount an auxiliary latch plate 46 at a selected location along the door jam other than at the site of the door's latch 50 and then the removable lock device of the present invention can be used in addition to any dead bolt or other type of lock mechanism that may be built into the doorknob assembly.

This invention has been described herein in considerable detail in order to comply with the patent statutes and to provide those skilled in the art with the information needed to apply the novel principles and to construct and use such specialized components as are required. However, it is to be understood that the invention can be carried out by specifically different equipment and devices, and that various modifications, both as to the equipment and operating procedures, can be accomplished without departing from the scope of the invention itself

What is claimed is:

1. A portable lock mechanism for preventing an entry door mounted in a door jam from being opened, comprising:
(a) a rigid, generally rectangular strap member having first and second ends and a predetermined width dimension, the strap member including a pattern of apertures extending through a thickness dimension thereof at differing distances from said first end;
(b) a stud member affixed to said strap member proximate said one end and projecting normally from the strap member and sized for insertion into a recess in a door jam;
(c) a rigid plate member sized to span a gap between a surface of the entry door and a surface of the door jam when the door is closed with respect to the door jam, the plate member having a slot formed therethrough of a length greater than the predetermined width dimension of the strap member such that the strap member is slidable through said slot; and
(d) a pin adapted to be inserted through a selected one of said apertures.

2. The portable lock mechanism wherein the pin is affixed to the strap member by a flexible tether.

3. The portable lock mechanism of claim 2 wherein the flexible tether is a length of chain or a cable.

4. The portable lock mechanism as in claim 1 and further including a smooth resilient pad affixed to one major surface of the plate member.

5. The portable lock mechanism as in claim 4 wherein the resilient pad is made of one of foam rubber and cork.

6. The portable lock mechanism as in claim 1 wherein the strap member includes a bend extending across said width dimension such that the first and second ends are non-coplanar.

7. The portable lock mechanism as in claim 6 wherein the pattern of apertures is located between said bend and said first end.

8. The portable lock mechanism as in claim 1 wherein the pin includes a spring-loaded ball-detent member.

9. A method for locking an entry door to an adjacent door jam comprising the steps of:
(a) providing the device of claim 1;
(b) opening the door with respect to the door jam sufficiently far to allow insertion of the stud member into the recess in the door jam with the plate member slid toward said second end;
(c) closing the door against the door jam to capture the stud member in said recess;
(d) sliding the plate member along the strap member until it abuts the door and door jam; and
(e) inserting the pin through the selected one of said apertures.
